(19) United States
(12) Patent Application Publication
(10) Pub. No.: US 2016/0373523 A1
(43) Pub. Date: Dec. 22, 2016

(54) PROFILE MANAGEMENT METHOD AND APPARATUS FOR RUNNING OF VIRTUAL DESKTOP IN HETEROGENEOUS SERVER

(71) Applicant: Electronics and Telecommunications Research Institute, Daejeon (KR)

(72) Inventors: Dae-Won KIM, Daejeon (KR); Sun-Wook KIM, Gyeonggi-do (KR); Seong-Woon KIM, Chungcheongnam-do (KR); Jong-Bae MOON, Daejeon (KR); Byeong-Thaek OH, Daejeon (KR); Soo-Cheol OH, Daejeon (KR); Jung-Hyun CHO, Daejeon (KR); Hag-Young KIM, Daejeon (KR); Myeong-Hoon OH, Daejeon (KR); Ji-Hyeok CHOI, Gyeonggi-do (KR)

(21) Appl. No.: 15/132,808

(22) Filed: Apr. 19, 2016

(30) Foreign Application Priority Data
Jun. 19, 2015 (KR) 10-2015-0087394

(51) Int. Cl. H04L 29/08

(52) U.S. Cl. CPC H04L 67/1008; H04L 67/306; H04L 67/1097

(57) ABSTRACT

A profile management method and apparatus for the running of a virtual desktop in a heterogeneous server are disclosed herein. The profile management method for the running of a virtual desktop in a heterogeneous server, includes: assigning any optimum one of a plurality of operating servers that will run a virtual desktop; comparing a plurality of hardware profiles corresponding to the plurality of operating servers with a target hardware profile corresponding to the optimum operating server; if the target hardware profile is not present among the plurality of hardware profiles, generating a virtual desktop running profile for the running of the virtual desktop based on the target hardware profile; and sharing the virtual desktop running profile, as well as at least one profile required for the running of the virtual desktop, with the optimum operating server so that the optimum operating server runs the virtual desktop.

### CROSS-REFERENCE TO RELATED APPLICATION

This application claims the benefit of Korean Patent Application No. 10-2015-0087394, filed on Jun. 19, 2015, which is hereby incorporated by reference herein in its entirety.

### BACKGROUND

1. Technical Field

The present disclosure relates generally to profile management technology for the running of a virtual desktop in a heterogeneous server environment, and more particularly to profile management technology that can share profiles, required for the running of virtual desktops, with operating servers that run the virtual desktops and that can run a virtual desktop on a heterogeneous server in the same environment.

2. Description of the Related Art

According to conventional virtual desktop technology, Microsoft provides terminal service called Remote Desktop Connection (RDC) using the Remote Desktop Protocol (RDP), and Linux provides terminal service called Virtual Network Computing (VNC) using the Remote Frame Buffer (RFB) protocol. Furthermore, Teradici provides a terminal service solution using a protocol called PC-over-IP (PCoIP).

In order to perform virtual desktop service using such a method, a virtual desktop function must be provided to each user, and a corresponding device (CPU, memory, HDD, USB, or the like) and an operating system (OS) image for a user must be assigned to the user in order to provide the virtual desktop function.

Although an open tool, such as virt-tool, virt-manager, or the like, is being used to provide the above function and a virtual desktop or virtual machine for a user may be generated using a program, such as xendesktop of Citrix Systems Inc., VMware Fusion or workstation, this is a tool that is provided using a manual method, and thus is not appropriate for the provision of real-time virtual service. Furthermore, a method for providing a running environment in a different heterogeneous server environment is not appropriate.

Therefore, there is a pressing need for technology for running a virtual desktop in the same manner in a different heterogeneous server environment.

### Preceding Technology Document

### Patent Document

Patent document 1: Korean Patent Publication No. 10-0763781 published on Oct. 5, 2007 and entitled “Server Management System and Migration Method”

### SUMMARY

At least one embodiment of the present invention is intended to, in the case of providing virtual desktop service in a different heterogeneous server environment, provide profile management technology capable of more effectively providing virtual desktop service, instead of a method in which a user provides virtual desktop service by manually modifying a profile or performing migration during a long period of time.

At least one embodiment of the present invention is intended to store a profile for the running of a virtual desktop in the memory of a server that runs the virtual desktop, thereby further improving the performance of the virtual desktop.

According to an aspect of the present invention, there is provided a profile management method for the running of a virtual desktop in a heterogeneous server, including: assigning any optimum one of a plurality of operating servers that will run a virtual desktop; comparing a plurality of hardware profiles corresponding to the plurality of operating servers with a target hardware profile corresponding to the optimum operating server; if the target hardware profile is not present among the plurality of hardware profiles, generating a virtual desktop running profile for the running of the virtual desktop based on the target hardware profile; and sharing the virtual desktop running profile, as well as at least one profile required for the running of the virtual desktop, with the optimum operating server so that the optimum operating server runs the virtual desktop.

Assigning the optimum operating server may include, when the optimum operating server operates normally, assigning a backup operating server that is managed separately from the plurality of operating servers.

Assigning the optimum operating server may include assigning the optimum operating server by taking into account at least one of server availability and utilization corresponding to the plurality of operating servers.

Generating the virtual desktop running profile may include: generating a virtual desktop template corresponding to the target hardware profile; and generating the virtual desktop running profile using the virtual desktop template.

The profile management method may further include: collecting a plurality of pieces of hardware information from the plurality of operating servers; and storing the plurality of hardware profiles generated based on the plurality of pieces of hardware information.

The at least one profile may include at least one of a user profile corresponding to information about a user who has requested the virtual desktop and a virtual desktop state profile corresponding to information about a current state that is achieved by the user after the virtual desktop has been run.

Sharing the virtual desktop running profile, as well as the at least one profile, may include sharing a virtual desktop image for the booting of the virtual desktop with the plurality of operating servers.

The plurality of operating servers, when the user makes re-access and requests the virtual desktop, may load the virtual desktop state profile based on the user profile, and then may run the virtual desktop in accordance with the information about a current state.

The virtual desktop running profile may include at least one of the types of virtual devices and the number of virtual devices required for the running of the virtual desktop.

Collecting the plurality of pieces of hardware information may include collecting the plurality of pieces of hardware information using at least one of hardware information on operating systems (OSs) corresponding to the plurality of operating servers and the hardware controllers of the plurality of operating servers.

The virtual desktop state profile may be separately stored in MEM memory corresponding to each of the plurality of operating servers.

According to another aspect of the present invention, there is provided a profile management apparatus for the running of a virtual desktop in a heterogeneous server, including: a server assignment unit configured to assign any optimum one of a plurality of operating servers that will run a virtual desktop; a profile comparison unit configured to compare a plurality of hardware profiles corresponding to the plurality of operating servers with a target hardware profile corresponding to the optimum operating server; a profile generation unit configured to, if the target hardware profile is not present among the plurality of hardware profiles, generate a virtual desktop running profile for the running of the virtual desktop based on the target hardware profile; and shared storage configured to share the virtual desktop running profile, as well as at least one profile required for the running of the virtual desktop, with the optimum operating server so that the optimum operating server runs the virtual desktop.

The server assignment unit, when the optimum operating server operates normally, may assign a backup operating server that is managed separately from the plurality of operating servers.

The server assignment unit may assign the optimum operating server by taking into account at least one of server availability and utilization corresponding to the plurality of operating servers.

The profile generation unit may generate a virtual desktop template corresponding to the target hardware profile, and may generate the virtual desktop running profile using the virtual desktop template.

The profile management apparatus may further include: a hardware information collection unit configured to collect a plurality of pieces of hardware information from the plurality of operating servers; and a hardware profile database configured to store the plurality of hardware profiles generated based on the plurality of pieces of hardware information.

The at least one profile may include at least one of a user profile corresponding to information about a user who has requested the virtual desktop and a virtual desktop state profile corresponding to information about a current state that is achieved by the user after the virtual desktop has been run.

The shared storage may share a virtual desktop image for the booting of the virtual desktop with the plurality of operating servers.

The plurality of operating servers, when the user makes re-access and requests the virtual desktop, may load the virtual desktop state profile based on the user profile, and then may run the virtual desktop in accordance with the current state information.

The virtual desktop running profile may include at least one of the types of virtual devices and the number of virtual devices required for the running of the virtual desktop.

The hardware information collection unit may collect the plurality of pieces of hardware information using at least one of hardware information on operating systems (OSs) corresponding to the plurality of operating servers and the hardware controllers of the plurality of operating servers.

The virtual desktop state profile may be separately stored in MEM memory corresponding to each of the plurality of operating servers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an operation flowchart showing a profile management method for the running of a virtual desktop in a heterogeneous server according to an embodiment of the present invention;

FIG. 2 is an operation flowchart showing a profile management method for the running of a virtual desktop in a heterogeneous server according to an embodiment of the present invention in detail;

FIG. 3 is a block diagram showing a virtual desktop system using a profile management apparatus for the running of a virtual desktop in a heterogeneous server according to an embodiment of the present invention;

FIG. 4 is a block diagram showing an example of the profile management apparatus for the running of a virtual desktop in a heterogeneous server shown in FIG. 3; and

FIG. 5 is a diagram showing a virtual desktop system using a profile management apparatus for the running of a virtual desktop in a heterogeneous server according to an embodiment of the present invention in detail.

### DETAILED DESCRIPTION

Embodiments of the present invention will be described in detail below with reference to the accompanying drawings. Redundant descriptions and descriptions of well-known functions and configurations that may make the gist of the present invention unnecessarily obscure will be omitted below. The embodiments of the present invention are intended to more completely describe the present invention to persons having ordinary knowledge in the art to which the present invention pertains. Accordingly, the shapes, sizes and the like of components in the drawings may be exaggerated to make the description obvious.

Embodiments of the present invention will be described in detail with reference to the accompanying drawings below.

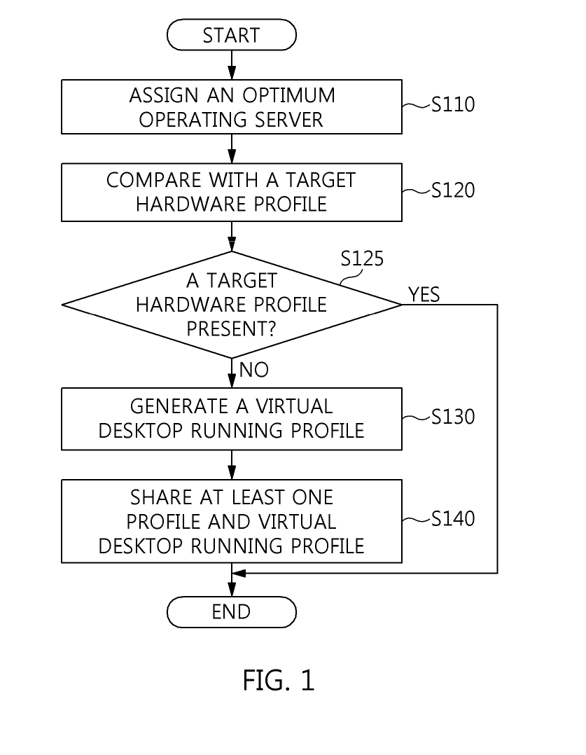

FIG. 1 is an operation flowchart showing a profile management method for the running of a virtual desktop in a heterogeneous server according to an embodiment of the present invention.

In the case of a conventional virtual desktop system, a user can run a virtual desktop by manually modifying a profile or performing migration during a long period of time in order to run the virtual desktop in a heterogeneous different server. However, this method is cumbersome and consumes a long period of time, which causes a problem related to the operation of a system. Accordingly, the present invention is intended to provide a method of storing and using a user profile, a virtual desktop image and a virtual desktop running profile in shared storage in order to run a virtual desktop in a different heterogeneous server.

Referring to FIG. 1, the profile management method for the running of a virtual desktop in a heterogeneous server according to the present embodiment may include assigning any optimum one of a plurality of operating servers that will run a virtual desktop at step S110. For example, a user may access a virtual desktop system via login, thereby requesting the assignment of a virtual desktop. In order to run the virtual desktop, an optimum operating server that can run the virtual desktop may be assigned first.

In this case, any one of the plurality of operating servers can run the virtual desktop that is requested by the user, and may need to generate a profile that is required for the purpose.

In this case, when the optimum operating server does not operate normally, a backup operating server that is managed separately from the plurality of operating servers may be assigned. For example, a plurality of operating servers and a single backup operating server may be provided in an N+1 form, and the single backup operating server may be always put on standby in a service ready state. When an operating server that has performed service becomes down, the backup operating server on standby may be recognized in real time, and may run a virtual desktop that has been served by the down operating server. Using the backup operating server, the availability of the overall system can be improved.

In this case, the optimum operating server may be assigned by taking into account at least one of server availability and utilization corresponding to the plurality of operating servers. That is, one of the plurality of operating servers that is most appropriate for load balancing may be determined to be the optimum operating server, and then may be assigned.

Furthermore, the profile management method for the running of a virtual desktop in a heterogeneous server according to the present embodiment may include comparing a plurality of hardware profiles corresponding to the plurality of operating servers with a target hardware profile corresponding to the optimum operating server at step S120.

That is, it may be determined whether the target hardware profile is present among the plurality of hardware profiles at step S125.

In this case, each of the hardware profiles may correspond to a profile including the hardware information of an operating server to which a user refers in order to generate a virtual desktop. Accordingly, the plurality of operating servers may include respective different pieces of hardware information.

Accordingly, whether the optimum operating server is a previously present server or a heterogeneous server may be determined by comparing the hardware profiles.

The profile management method for the running of a virtual desktop in a heterogeneous server according to the present embodiment may include, if, as a result of the determination at step S125, it is determined that the target hardware profile is not present among the plurality of hardware profiles, generating a virtual desktop running profile for the running of the virtual desktop based on the target hardware profile at step S130.

Furthermore, if, as a result of the determination at step S125, it is determined that the target hardware profile is present among the plurality of hardware profiles, the virtual desktop may be run because the virtual desktop profile is present in the shared storage.

That is, the fact that information identical to the target hardware profile is not present among the plurality of hardware profiles may mean that the optimum operating server corresponding to the target hardware profile is a heterogeneous operating server that has not been assigned. That is, since the optimum operating server has different hardware characteristics, it may not use a virtual desktop running profile that is shared via the shared storage. Therefore, a virtual desktop running profile that is required by the optimum operating server to run the virtual desktop may be generated.

In this case, a virtual desktop template corresponding to the target hardware profile may be generated, and the virtual desktop running profile may be generated using the virtual desktop template. Furthermore, corresponding virtual desktop templates may be present for the plurality of respective operating servers, and the information of the virtual desktop templates present in the system may be updated to include the virtual desktop template that is generated in accordance with the target hardware profile.

In this case, the virtual desktop running profile may include at least one of the types of virtual devices and the number of virtual devices that are required for the running of the virtual desktop. For example, the virtual desktop running profile may include information corresponding to a virtual CPU, memory, a hard disk and various types of devices.

Furthermore, the profile management method for the running of a virtual desktop in a heterogeneous server according to the present embodiment may include sharing the virtual desktop running profile, as well as at least one profile required for the running of the profile virtual desktop, with the optimum operating server so that the optimum operating server can run the virtual desktop at step S140.

In this case, the at least one profile may include at least one of a user profile corresponding to information about the user who has requested the virtual desktop and a virtual desktop state profile corresponding to information about a current state that is achieved by the user after the virtual desktop has been run. That is, the optimum operating server may run the virtual desktop using the virtual desktop running profile, the user profile and the virtual desktop state profile. For example, the user profile may include personal information corresponding to the ID, password and identification information of the user, information such as the virtual desktop name of the user, and virtual desktop environment information such as a Windows user profile.

In this case, a virtual desktop image for the booting of the virtual desktop may be shared with the plurality of operating servers. The virtual desktop image may correspond to the virtual disk of the virtual desktop. That is, the virtual desktop may be booted using the virtual disk, as in the case where booting is performed from a remote location.

In this case, when the user makes re-access and requests the virtual desktop, the plurality of operating servers may load a virtual desktop state profile based on the user profile, and may run the virtual desktop in accordance with the information about a current state. For example, when the virtual desktop is run, a state in which the virtual desktop has been run may be stored and updated in the form of a profile. The virtual desktop state profile may correspond to this profile. Accordingly, since the virtual desktop state profile includes memory information about the current situation of the user, the operating server may load the virtual desktop state profile and maintain the environment of the user without change when the user makes re-access later.

In this case, the virtual desktop state profile may be separately stored in MEM memory corresponding to each of the plurality of operating servers.

That is, it may be difficult to compare the performance of the virtual desktop with the performance of a general PC because booting speed and operation speed are low due to the provision of service basically using an emulated hardware device and because the I/O of a storage device is limited. Accordingly, in order to overcome the above-described speed limitations, the user profile required for the running of the virtual desktop and a virtual machine state profile including current state information are stored and used in the MEM memory of the operating server, thereby using them to improve the running speed of the virtual desktop.

Furthermore, although not shown in FIG. 1, the profile management method for the running of a virtual desktop in a heterogeneous server according to the present embodiment may include collecting a plurality of pieces of hardware information from the plurality of operating servers.

In this case, the plurality of pieces of hardware information may be collected using at least one of hardware information on the OSs corresponding to the plurality of operating servers and the hardware controllers of the plurality of operating servers. For example, the hardware information on each of the OSs may refer to a repository in the case of Windows or a proc file system in the case of Linux. Furthermore, the profile management apparatus accesses a Baseboard Management Controller (BMC) that is present in each of the plurality of operating servers and is generated for out-of-band management, and may collect hardware information using a network.

In this case, the plurality of operating servers may include an agent for the collection of hardware information, and may transmit the hardware information to the profile management apparatus using the agent.

Furthermore, although not shown in FIG. 1, the profile management method for the running of a virtual desktop in a heterogeneous server according to the present embodiment may include storing a plurality of hardware profiles that is generated based on the plurality of pieces of hardware information.

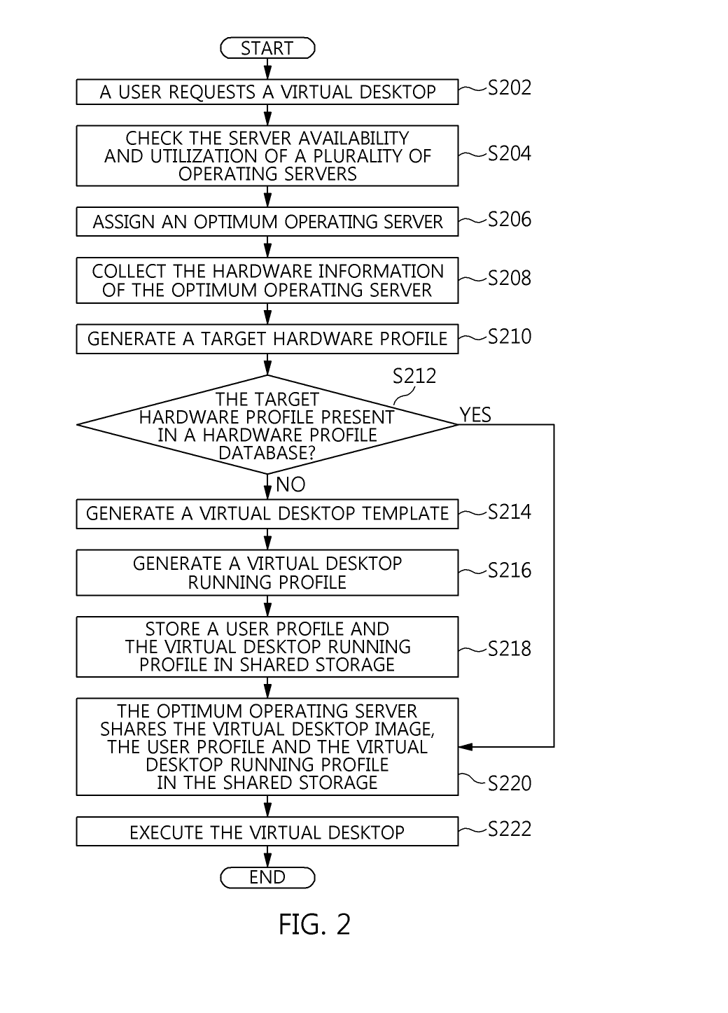

FIG. 2 is an operation flowchart showing a profile management method for the running of a virtual desktop in a heterogeneous server according to an embodiment of the present invention in detail.

Referring to FIG. 2, the profile management method for the running of a virtual desktop in a heterogeneous server according to the present embodiment may include a user accessing a virtual desktop system via login, thereby requesting the assignment of a virtual desktop at step S202.

Thereafter, in order to assign an optimum operating server, the server availability and utilization of a plurality of operating servers may be checked at step S204.

Thereafter, any optimum one of the plurality of operating servers that will run a virtual desktop may be assigned at step S206. That is, one of the plurality of operating servers that is most appropriate for load balancing may be determined to be the optimum operating server, and then may be assigned.

Thereafter, the hardware information of the optimum operating server may be collected at step S208.

In this case, the hardware information of the optimum operating server may be collected using at least one of hardware information on an OS corresponding to the optimum operating server and the hardware controller of the optimum operating server.

Thereafter, a target hardware profile may be generated based on the hardware information of the optimum operating server at step S210.

Thereafter, it is determined whether the target hardware profile is present in a hardware profile database at step S212.

In this case, whether the target hardware profile is present may be determined by comparing a plurality of hardware profiles, corresponding to the plurality of operating servers included in the hardware profile database, with the target hardware profile corresponding to the optimum operating server.

If, as a result of the determination at step S212, the target hardware profile is not present, a virtual desktop template for the running of the virtual desktop may be generated based on the target hardware profile at step S214.

Thereafter, a virtual desktop running profile may be generated using the virtual desktop template at step S216.

Thereafter, a user profile and the virtual desktop running profile may be stored in shared storage at step S218.

In this case, the virtual desktop running profile may include information about at least one of the types of virtual devices and the number of virtual devices required for the running of the virtual desktop. For example, the virtual desktop running profile may include information corresponding to a virtual CPU, memory, a hard disk and various types of devices.

In this case, the user profile may be also stored in the shared storage. For example, the user profile may include personal information corresponding to the ID, password and identification information of the user, information such as the virtual desktop name of the user, and virtual desktop environment information such as a Windows user profile.

Thereafter, the optimum operating server may share a virtual desktop image, the user profile and virtual desktop running profile in the shared storage at step S220.

In this case, the virtual desktop image may correspond to the virtual disk of the virtual desktop. That is, the virtual desktop may be booted using the virtual disk, as in the case where booting is performed from a remote location.

Thereafter, the virtual desktop may be run on the optimum operating server at step S222.

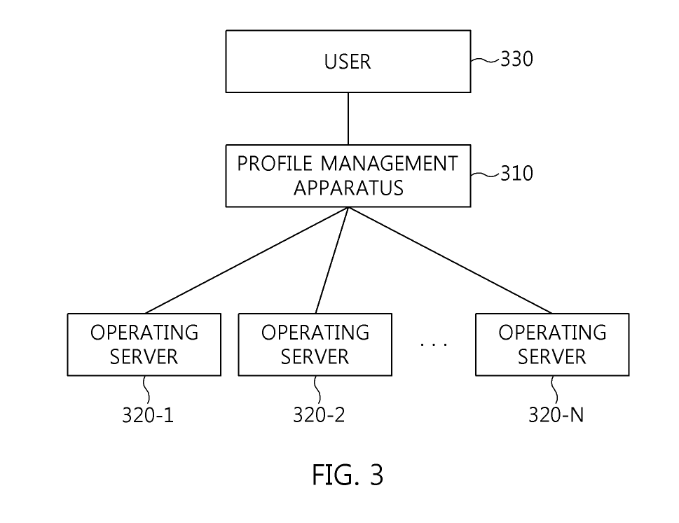

FIG. 3 is a block diagram showing a virtual desktop system using a profile management apparatus for the running of a virtual desktop in a heterogeneous server according to an embodiment of the present invention.

Referring to FIG. 3, the virtual desktop system using a profile management apparatus for the running of a virtual desktop in a heterogeneous server may include a profile management apparatus 310, operating servers 320-1 to 320-N, and a user 330.

The profile management apparatus 310 may assign any optimum one of the plurality of operating server operating servers 320-1 to 320-N that will run a virtual desktop.

In this case, when the optimum operating server does not operate normally, a backup operating server that is managed separately from the plurality of operating servers 320-1 to 320-N may be assigned.

In this case, the optimum operating server may be assigned by taking into account at least one of server availability and utilization corresponding to the plurality of operating servers 320-1 to 320-N.

Furthermore, the profile management apparatus 310 may collect a plurality of pieces of hardware information from the plurality of operating servers 320-1 to 320-N.

In this case, the plurality of pieces of hardware information may be collected using at least one of hardware information on OSs corresponding to the plurality of operating servers 320-1 to 320-N and the hardware controllers of the plurality of operating servers 320-1 to 320-N.

Furthermore, the profile management apparatus 310 may store a plurality of hardware profiles that are generated based on a plurality of pieces of hardware information.

Furthermore, the profile management apparatus 310 may compare the plurality of hardware profiles, corresponding to the plurality of operating servers 320-1 to 320-N, with a target hardware profile corresponding to the optimum operating server.

Furthermore, the profile management apparatus 310 may generate a virtual desktop running profile for the running of the virtual desktop based on the target hardware profile when the target hardware profile is not present among the plurality of hardware profiles.

In this case, a virtual desktop template corresponding to the target hardware profile may be generated, and the virtual desktop running profile may be generated using the virtual desktop template.

In this case, the virtual desktop running profile may include at least one of types of virtual devices and the number of virtual devices required for the running of the virtual desktop.

Furthermore, the profile management apparatus 310 may share the virtual desktop running profile, as well as at least one profile required for the running of the virtual desktop, with the optimum operating server so that the optimum operating server can run the virtual desktop.

In this case, the at least one profile may include at least one of a user profile corresponding to information about the user 330 who has requested the virtual desktop and a virtual desktop state profile corresponding to information about a current state that is achieved by the user 330 after the virtual desktop has been run.

In this case, a virtual desktop image for the booting of the virtual desktop may be shared with the plurality of operating servers 320-1 to 320-N.

In this case, when the user 330 makes re-accesses and requests the virtual desktop, the plurality of operating servers 320-1 to 320-N may load the virtual desktop state profile based on the user profile, and may run the virtual desktop in accordance with the information about a current state.

In this case, the virtual desktop state profile may be separately stored in MEM memory corresponding to each of the plurality of operating servers 320-1 to 320-N.

The operating servers 320-1 to 320-N may be servers that are assigned to the user 330 in order to run the virtual desktop. That is, the user may access the virtual desktop service system and request the virtual desktop, and the profile management apparatus 310 may assign any optimum one of the plurality of operating servers 320-1 to 320-N that is most appropriate for the running of the virtual desktop.

The user 330 may access the virtual desktop service system in order to receive a virtual desktop service, and may be assigned and use the virtual desktop that runs on the optimum operating server assigned via the profile management apparatus 310.

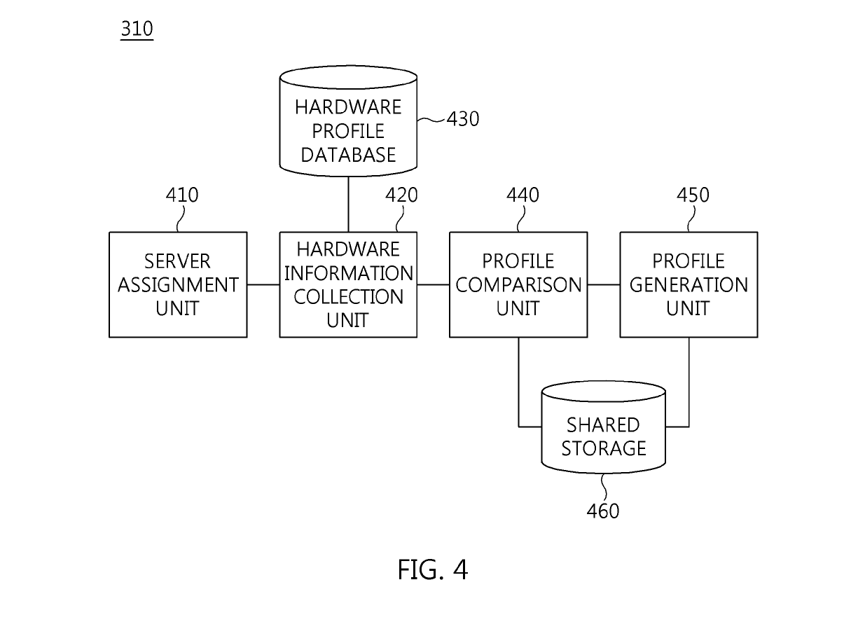

FIG. 4 is a block diagram showing an example of the profile management apparatus for the running of a virtual desktop in a heterogeneous server shown in FIG. 3.

In the case of a conventional virtual desktop system, a user can run a virtual desktop by manually modifying a profile or performing migration during a long period of time in order to run the virtual desktop in a heterogeneous different server. However, this method is cumbersome and consumes a long period of time, which causes a problem related to the operation of a system. Accordingly, the present invention is intended to provide a method of storing and using a user profile, a virtual desktop image and a virtual desktop running profile in shared storage in order to run a virtual desktop in a different heterogeneous server.

Referring to FIG. 4, the profile management apparatus 310 for the running of a virtual desktop in a heterogeneous server shown in FIG. 3 may include a server assignment unit 410, a hardware information collection unit 420, a hardware profile database 430, a profile comparison unit 440, a profile generation unit 450, and shared storage 460.

The server assignment unit 410 may assign any optimum one of a plurality of operating servers that will run a virtual desktop. For example, a user may access a virtual desktop system via login, thereby requesting the assignment of a virtual desktop. In order to run the virtual desktop, an optimum operating server that can run the virtual desktop may be assigned first.

In this case, any one of the plurality of operating servers can run the virtual desktop that is requested by the user, and may need to generate a profile that is required for the purpose.

In this case, when the optimum operating server does not operate normally, a backup operating server that is managed separately from the plurality of operating servers may be assigned. For example, a plurality of operating servers and a single backup operating server may be provided in an N+1 form, and the single backup operating server may be always put on standby in a service ready state. When an operating server that has performed service becomes down, the backup operating server on standby may be recognized in real time, and may run a virtual desktop that has been served by the down operating server. Using the backup operating server, the availability of the overall system can be improved.

In this case, the optimum operating server may be assigned by taking into account at least one of server availability and utilization corresponding to the plurality of operating servers. That is, one of the plurality of operating servers that is most appropriate for load balancing may be determined to be the optimum operating server, and then may be assigned.

The hardware information collection unit 420 may collect a plurality of pieces of hardware information from the plurality of operating servers.

In this case, the plurality of pieces of hardware information may be collected using at least one of hardware information on the OSs corresponding to the plurality of operating servers and the hardware controllers of the plurality of operating servers. For example, the hardware information on each of the OSs may refer to a repository in the case of Windows or a proc file system in the case of Linux. Furthermore, the profile management apparatus accesses a Baseboard Management Controller (BMC) that is present in each of the plurality of operating servers and is generated for out-of-band management, and may collect hardware information using a network.

In this case, the plurality of operating servers may include an agent for the collection of hardware information, and may transmit the hardware information to the profile management apparatus using the agent.

Furthermore, the hardware profile database 430 may store a plurality of hardware profiles that is generated based on the plurality of pieces of hardware information.

The profile comparison unit 440 may compare a plurality of hardware profiles corresponding to the plurality of operating servers with a target hardware profile corresponding to the optimum operating server.

That is, it may be determined whether the target hardware profile is present among the plurality of hardware profiles.

In this case, each of the hardware profiles may correspond to a profile including the hardware information of an operating server to which a user refers in order to generate a virtual desktop. Accordingly, the plurality of operating servers may include respective different pieces of hardware information.

Accordingly, whether the optimum operating server is a previously present server or a heterogeneous server may be determined by comparing the hardware profiles.

The profile generation unit 450 may generate a virtual desktop running profile for the running of the virtual desktop based on the target hardware profile if the target hardware profile is not present among the plurality of hardware profiles.

Furthermore, if the target hardware profile is present among the plurality of hardware profiles, the virtual desktop may be run because the virtual desktop profile is present in the shared storage.

That is, the fact that information identical to the target hardware profile is not present among the plurality of hardware profiles may mean that the optimum operating server corresponding to the target hardware profile is a heterogeneous operating server that has not been assigned. That is, since the optimum operating server has different hardware characteristics, it may not use a virtual desktop running profile that is shared via the shared storage. Therefore, a virtual desktop running profile that is required by the optimum operating server to run the virtual desktop may be generated.

In this case, a virtual desktop template corresponding to the target hardware profile may be generated, and the virtual desktop running profile may be generated using the virtual desktop template. Furthermore, corresponding virtual desktop templates may be present for the plurality of respective operating servers, and the information of the virtual desktop templates present in the system may be updated to include the virtual desktop template that is generated in accordance with the target hardware profile.

In this case, the virtual desktop running profile may include at least one of the types of virtual devices and the number of virtual devices that are required for the running of the virtual desktop. For example, the virtual desktop running profile may include information corresponding to a virtual CPU, memory, a hard disk and various types of devices.

The shared storage 460 may share the virtual desktop running profile, as well as at least one profile required for the running of the profile virtual desktop, with the optimum operating server so that the optimum operating server can run the virtual desktop.

In this case, the at least one profile may include at least one of a user profile corresponding to information about the user who has requested the virtual desktop and a virtual desktop state profile corresponding to information about a current state that is achieved by the user after the virtual desktop has been run. That is, the optimum operating server may run the virtual desktop using the virtual desktop running profile, the user profile and the virtual desktop state profile. For example, the user profile may include personal information corresponding to the ID, password and identification information of the user, information such as the virtual desktop name of the user, and virtual desktop environment information such as a Windows user profile.

In this case, a virtual desktop image for the booting of the virtual desktop may be shared with the plurality of operating servers. The virtual desktop image may correspond to the virtual disk of the virtual desktop. That is, the virtual desktop may be booted using the virtual disk, as in the case where booting is performed from a remote location.

In this case, when the user makes re-access and requests the virtual desktop, the plurality of operating servers may load a virtual desktop state profile based on the user profile, and may run the virtual desktop in accordance with the information about a current state. For example, when the virtual desktop is run, a state in which the virtual desktop has been run may be stored and updated in the form of a profile. The virtual desktop state profile may correspond to this profile. Accordingly, since the virtual desktop state profile includes memory information about the current situation of the user, the operating server may load the virtual desktop state profile and maintain the environment of the user without change when the user makes re-access later.

In this case, the virtual desktop state profile may be separately stored in MEM memory corresponding to each of the plurality of operating servers.

That is, it may be difficult to compare the performance of the virtual desktop with the performance of a general PC because booting speed and operation speed are low due to the provision of service basically using an emulated hardware device and because the I/O of a storage device is limited. Accordingly, in order to overcome the above-described speed limitations, the user profile required for the running of the virtual desktop and a virtual machine state profile including current state information are stored and used in the MEM memory of the operating server, thereby using them to improve the running speed of the virtual desktop.

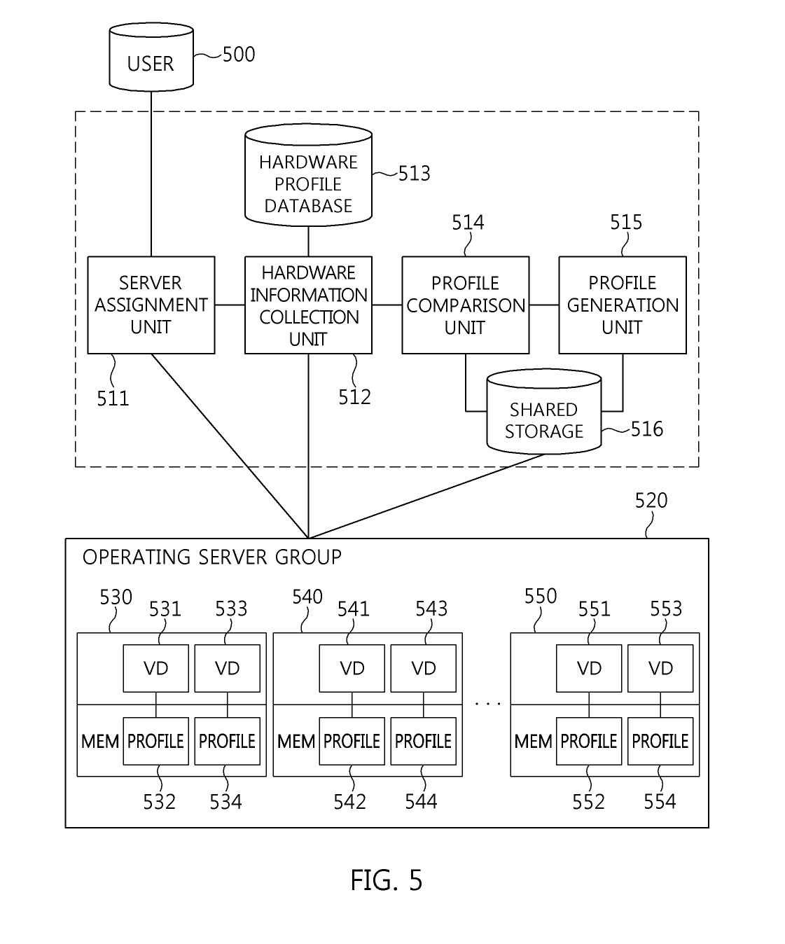

FIG. 5 is a diagram showing a virtual desktop system using a profile management apparatus for the running of a virtual desktop in a heterogeneous server according to an embodiment of the present invention in detail.

Referring to FIG. 5, the virtual desktop system using the profile management apparatus for the running of a virtual desktop in a heterogeneous server according to an embodiment of the present invention may include a user 500, a profile management apparatus 510, and operating servers 530, 540 and 550 included in an operating server group 520.

A profile management process for the running of a virtual desktop in a heterogeneous server using the components included in FIG. 5 is described below.

First, when the assignment of a virtual desktop is requested by the user 500, the server assignment unit 511 of the profile management apparatus 510 may assign an optimum one of the plurality of operating servers 530, 540 and 550 included in the operating server group 520.

In this case, the optimum operating server may be assigned by taking into account server availability and utilization corresponding to each of the plurality of operating servers 530, 540 and 550.

For example, when it is assumed that the operating server 530 is an optimum operating server and a heterogeneous operating server, a hardware information collection unit 512 may collect the hardware information of the operating server 530, may generate a target hardware profile, and may store the target hardware profile in a hardware profile database 513.

Thereafter, a profile comparison unit 514 may compare a plurality of hardware profiles stored in the hardware profile database 513 with the target hardware profile.

In this case, since the operating server 530 is a heterogeneous server, a hardware profile corresponding to the target hardware profile may not be present among the plurality of hardware profiles.

Accordingly, a profile generation unit 515 may generate a virtual desktop template corresponding to the target hardware profile in order to run the virtual desktop on the operating server 530, and may generate a virtual desktop running profile corresponding to the operating server 530 using the virtual desktop template.

Thereafter, the generated virtual desktop running profile, together with a user profile, is stored in shared storage 516, thereby being shared by the plurality of operating servers 540 and 550 as well as the operating server 530, i.e., the optimum operating server.

Accordingly, the operating server 530 assigned to the user may share the virtual desktop image, the user profile and the virtual desktop running profile via the shared storage 516, thereby running virtual desktops 531 and 533 using them.

For example, when it is assumed that the user 500 makes re-access and requests the assignment of the same virtual desktop, a virtual desktop state profile stored in at least one of MEM memories 532, 534, 542, 544, 552 and 554 corresponding to the shared storage 516 and the plurality of operating servers 530, 540 and 550 may be loaded, and the virtual desktop may be run in an environment that has been used by the user 550. Furthermore, the virtual desktop state profile may be stored and used in the MEM memory 532, 534, 542, 544, 552 and 554, thereby reducing the time it takes to run the virtual desktop and thus providing more effective service.

As described above, at least one embodiment of the present invention has the advantage of, in the case of providing virtual desktop service in a different heterogeneous server environment, providing profile management technology capable of more effectively providing virtual desktop service, instead of a method in which a user provides virtual desktop service by manually modifying a profile or performing migration during a long period of time.

At least one embodiment of the present invention has the advantage of storing a profile for the running of a virtual desktop in the memory of a server that runs the virtual desktop, thereby further improving the performance of the virtual desktop.

The above-described profile management method and apparatus for the running of a virtual desktop in a heterogeneous server according to the present invention are not limited to the configurations and methods of the above-described embodiments, but some or all of the embodiments may be selectively combined such that the embodiments can be modified in various manners.

What is claimed is:

1. A profile management method for running of a virtual desktop in a heterogeneous server, comprising:
assigning any optimum one of a plurality of operating servers that will run a virtual desktop;
comparing a plurality of hardware profiles corresponding to the plurality of operating servers with a target hardware profile corresponding to the optimum operating server;
if the target hardware profile is not present among the plurality of hardware profiles, generating a virtual desktop running profile for the running of the virtual desktop based on the target hardware profile; and
sharing the virtual desktop running profile, as well as at least one profile required for the running of the virtual desktop, with the optimum operating server so that the optimum operating server runs the virtual desktop.

2. The profile management method of claim 1, wherein assigning the optimum operating server comprises, when the optimum operating server operates normally, assigning a backup operating server that is managed separately from the plurality of operating servers.

3. The profile management method of claim 2, wherein assigning the optimum operating server comprises assigning the optimum operating server by taking into account at least one of server availability and utilization corresponding to the plurality of operating servers.

4. The profile management method of claim 1, wherein generating the virtual desktop running profile comprises:
generating a virtual desktop template corresponding to the target hardware profile; and
generating the virtual desktop running profile using the virtual desktop template.

5. The profile management method of claim 4, further comprising:
collecting a plurality of pieces of hardware information from the plurality of operating servers; and
storing the plurality of hardware profiles generated based on the plurality of pieces of hardware information.

6. The profile management method of claim 1, wherein the at least one profile comprises at least one of a user profile corresponding to information about a user who has requested the virtual desktop and a virtual desktop state profile corresponding to information about a current state that is achieved by the user after the virtual desktop has been run.

7. The profile management method of claim 1, wherein sharing the virtual desktop running profile, as well as the at least one profile, comprises sharing a virtual desktop image for booting of the virtual desktop with the plurality of operating servers.

8. The profile management method of claim 6, wherein the plurality of operating servers, when the user makes re-access and requests the virtual desktop, loads the virtual desktop state profile based on the user profile, and then runs the virtual desktop in accordance with the information about a current state.

9. The profile management method of claim 1, wherein the virtual desktop running profile comprises at least one of types of virtual devices and a number of virtual devices required for the running of the virtual desktop.

10. The profile management method of claim 5, wherein collecting the plurality of pieces of hardware information comprises collecting the plurality of pieces of hardware information using at least one of hardware information on operating systems (OSs) corresponding to the plurality of operating servers and hardware controllers of the plurality of operating servers.

11. The profile management method of claim 8, wherein the virtual desktop state profile is separately stored in MEM memory corresponding to each of the plurality of operating servers.

12. A profile management apparatus for running of a virtual desktop in a heterogeneous server, comprising:
a server assignment unit configured to assign any optimum one of a plurality of operating servers that will run a virtual desktop;
a profile comparison unit configured to compare a plurality of hardware profiles corresponding to the plurality of operating servers with a target hardware profile corresponding to the optimum operating server;
a profile generation unit configured to, if the target hardware profile is not present among the plurality of hardware profiles, generate a virtual desktop running profile for the running of the virtual desktop based on the target hardware profile; and
shared storage configured to share the virtual desktop running profile, as well as at least one profile required for the running of the virtual desktop, with the optimum operating server so that the optimum operating server runs the virtual desktop.

13. The profile management apparatus of claim 12, wherein the server assignment unit, when the optimum operating server operates normally, assigns a backup operating server that is managed separately from the plurality of operating servers.

14. The profile management apparatus of claim 13, wherein the server assignment unit assigns the optimum operating server by taking into account at least one of server availability and utilization corresponding to the plurality of operating servers.

15. The profile management apparatus of claim 12, wherein the profile generation unit generates a virtual desktop template corresponding to the target hardware profile, and generates the virtual desktop running profile using the virtual desktop template.

16. The profile management apparatus of claim 15, further comprising:
a hardware information collection unit configured to collect a plurality of pieces of hardware information from the plurality of operating servers; and
a hardware profile database configured to store the plurality of hardware profiles generated based on the plurality of pieces of hardware information.

17. The profile management apparatus of claim 12, wherein the at least one profile comprises at least one of a user profile corresponding to information about a user who has requested the virtual desktop and a virtual desktop state profile corresponding to information about a current state that is achieved by the user after the virtual desktop has been run.

18. The profile management apparatus of claim 17, wherein the shared storage shares a virtual desktop image for booting of the virtual desktop with the plurality of operating servers.

19. The profile management apparatus of claim 17, wherein the plurality of operating servers, when the user makes re-access and requests the virtual desktop, loads the virtual desktop state profile based on the user profile, and then runs the virtual desktop in accordance with the current state information.

20. The profile management apparatus of claim 19, wherein the virtual desktop state profile is separately stored in MEM memory corresponding to each of the plurality of operating servers.
